(19) United States
(12) Patent Application Publication
(10) Pub. No.: US 2005/0155081 A1
(43) Pub. Date: Jul. 14, 2005

(54) Remote control device for a set-top box with a two-way transmission function and its controlling method

(76) Inventor: Kuo-Tsai Chiou, Hsin Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,470

(22) Filed: Jan. 9, 2004

(51) Int. Cl. H04N 7/173; G06F 13/00; H04N 5/445; H04N 7/16; H04N 5/44

(52) U.S. Cl. 725/131; 725/38; 348/734; 725/100; 725/151

(57) ABSTRACT

The present invention is in related to a remote control device for a set-top box with a two-way transmission function and its controlling method, the device which comprises a set-top box and a handheld device, the set-top box and the handheld device have a transmitting unit and a receiving unit individually. The transmitting unit in the handheld device sends a controlling signal to the receiving unit in the set-top box firstly, and continuously the received controlling signal by the set-top box indicates a function for digital work inside the set-top box, therefore another reply signal is delivered by the transmitting unit of the set-top box back to the receiving unit in the handheld device while the assigned work being done, and constantly the handheld device displays relative information of the reply signal. Obviously, the present invention has the function of two-way communication as control and display to facilitate users and increase the scope of application.

### BACKGROUND OF THE INVENTION

1. Field of the Invention

The present invention relates to a remote control device for a set-top box with a two-way transmission function and its controlling method and particularly to a set-top box that has signal transmitting function and a handheld device that has signal receiving and displaying functions to enable the handheld device to control signals and perform inter-confirmations to increase the product application scope.

Remote handheld device has been widely used in various types of household appliances such as TV, audio system, air conditioning, camera, and the like. The signal transmission media being adopted mostly are infrared transmission. The handheld device generally has an infrared transmission device. The targeted devices have an infrared receiving device. The handheld device has function keys to provide various functions. Once a function key is depressed, a control signal is modulated and transformed to an infrared signal for emitting. The infrared receiving device in the target device receives the signal and demodulates to generate a corresponding control action. This is a simple and single function control. One for transmitting, while another for receiving. As the household appliance has to perform only the controlled action, there is no interaction between user and the appliance.

In recent years, with rapid advances of broadband technologies, the broadband environment has gradually appeared in people's life. Set-top box is one of the important new technologies. Adopting the broadband characteristics and through the set-top box, people can access networks easily to see more programs in many channels. As digital program contents have gradually become the trend of the programs in the future, this has become the main focus of content production. Broadband technologies are well developed to exploit this trend and focus. Nowadays set-top box has been used to see the digital contents. As the broadband network can transmit a huge amount of data at high speed, the limitation of channel spectrum no longer exists, and interactive digital TV programs are feasible and can be materialized.

At present the set-top boxes mostly are coupled with handheld devices or wireless keypads. Users issue instructions to the set-top box through these control devices. The set-top box receives the instructions and generate a corresponding response. The signal transmission is an one way transmission. Namely, the handheld device issues a command to the set-top box, the set-top box receives and executes the commands. The set-top box is a passive receiving device and cannot generate any confirmation or reply to the user. Hence user cannot confirm whether the instruction related to the depressed key is really the required one or an error. Such an operation mode is not desirable in the future digital channels that focus interactive mechanism, especially the shopping channel. Moreover, the one-way remote control device at present has high degree of operational uncertainty and poor interactivity, there is still room for improvement.

### SUMMARY OF THE INVENTION

Therefore the primary object of the present invention is to provide a remote control device for a set-top box with a two-way transmission function and its controlling method. The device according to the invention includes a set-top box and a handheld device that have respectively a transmitting unit and a receiving unit. The handheld device has an input device which may receive instructions. The transmitting unit of the handheld device transmits the input signals to the set-top box. The receiving unit of the set-top box receives the signals and performs internal functions, and sends a reply signal to the handheld device. The handheld device receives the reply signal and displays the related messages on a display device on the handheld device for user confirmation of the input instructions. Hence the invention can provide a two-way transmission control or message display function to enhance use convenience and product application scope.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the structure of the invention.

FIG. 2 is another block diagram of the structure of the invention.

FIG. 3 is an operation flow chart of the invention.

### DESCRIPTION OF THE PREFERRED EMBODIMENTS

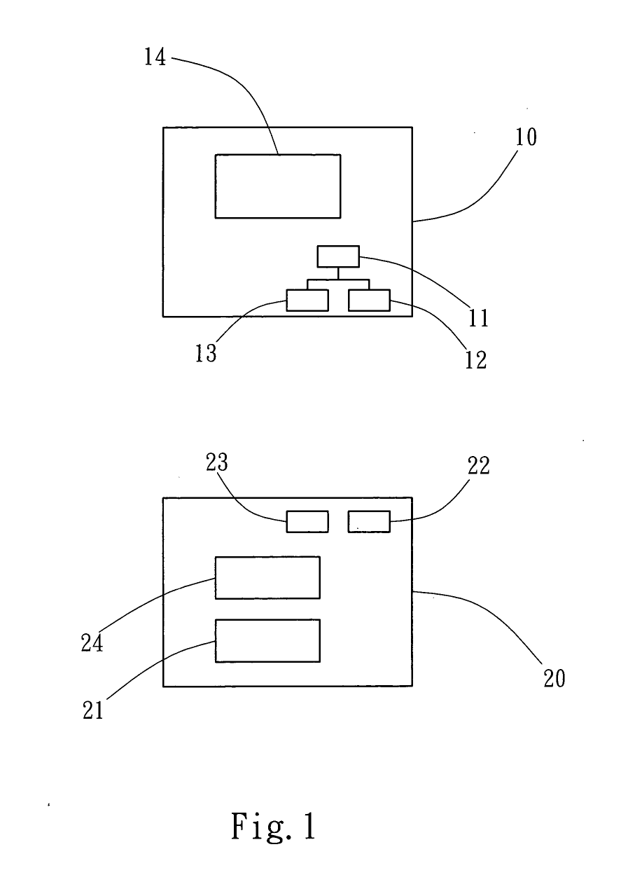

Referring to FIG. 1, the invention includes a set-top box 10, a handheld device 20 and a display device 24. The set-top box 10 has a transceiver board 11 which includes a first receiving unit 12 and a first transmitting unit 13. The first receiving unit 12 may receive operation and control signals transmitted from the handheld device 20, and transfer to a processing unit 14 in the set-top box 10 to process functions corresponding to the signals. The first transmitting unit 13 can generate and issue a confirmation signal according to the outcome and instructions of the functions being performed in the set-top box 10.

The hand-held device 20 includes an input device 21 for entering functional control and instructions, a second receiving unit 22 and a second transmitting unit 23. The second transmitting unit 23 corresponds to the first receiving unit 12 of the set-top box 10 and transmits the control signals generated by the input device 21 to the first receiving unit 12 of the set-top box 10. The second receiving unit 22 corresponds to the first transmitting unit 13 of the set-top box 10 for receiving reply signals transmitted from the first transmitting unit 13.

The display device 24 is located on the handheld device 20 for displaying the reply signals transmitted from the first transmitting unit 13 of the set-top box 10.

The receiving units 12 and 22 and the transmitting units 13 and 23 may transmit the signals through a transmission medium that may be either infrared transmission or radio frequency transmission.

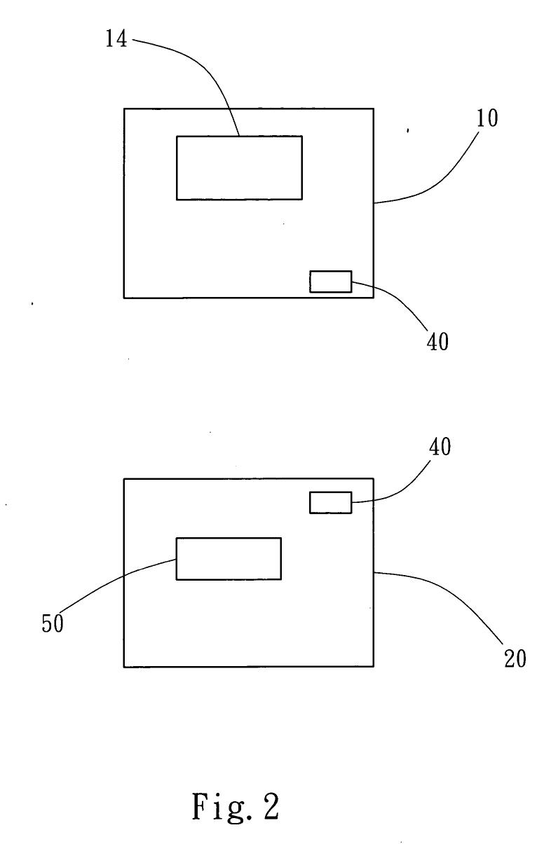

The display device 24 may be selected from the group consisting of indication light, multi-stage LED, liquid crystal display (LCD), and touch display panel (referring to FIG. 2).

The input device 21 may be selected from the group consisting of keyboard, touch panel, and touch display device (referring to FIG. 2).

The receiving units 12 and 22, and the transmitting units 13 and 23 may be independent units or be coupled to become one unit (also referring to FIG. 2).

After an user has entered control signals through the input device 21 of the handheld device 20, the second transmitting unit 23 of the handheld device 20 transmits the control signals to the first receiving unit 12 of the set-top box 10. The processing unit 14 of the set-top box 10 receives the control signals and executes functional operations to generate a confirmation signal which is transmitted through the first transmitting unit 13 to the second receiving unit 22 of the handheld device 20. The handheld device 20 receives the confirmation signal and displays corresponding messages on the display device 24 so that the user has a clear understanding of what control commands have been issued and can quickly verify the accuracy of the instructions.

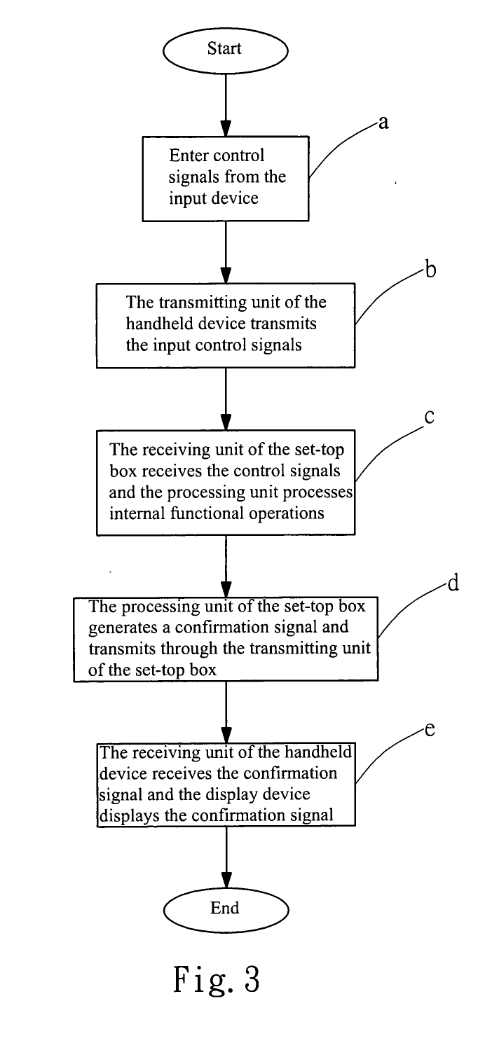

Refer to FIG. 3 for the processing procedures of the method for the remote control device for a two-way transmission function, the procedures include the following steps:

Step a: enter at least one control signal from the input device of the handheld device, and transfer the input signal to the transmitting unit of the handheld device;

Step b: the transmitting unit of the handheld device transmits the control signal entered from the input device of the handheld device to the receiving unit of the set-top box;

Step c: the receiving unit of the set-top box receives the control signal transmitted from the transmitting unit of the handheld device, and the processing unit of the set-top box receives and processes the control signal to generate a confirmation signal which is transferred to the transmitting unit of the set-top box;

Step d: the transmitting unit of the set-top box transmits the confirmation signal to the receiving unit of the handheld device; and

Step e: the receiving unit of the handheld device receives the confirmation signal transmitted from the transmitting unit of the set-top box, and the display device of the handheld device displays the received confirmation signal.

For instance, when an user depresses a SEARCH key 21, the second transmitting unit 23 of handheld device 20 issues a control signal to the first receiving unit 12 of the set-top box 10. The set-top box 10 performs searching operation according to the command, and the confirmation signal of the channel search is transmitted through the first transmitting unit 13 to the second receiving unit 23 of the handheld device 20. User can understand the operating function of the function key 21 from the display device 24, and verify whether the control action being executed is correct. Therefore the functions of the handheld device 20 and the set-top box 10 may be fully exploited and use convenience may be enhanced.

In summary, the remote control device for a set-top box with a two-way transmission function and its controlling method provided by the invention enables the set-top box to reply and confirm the function issued by the handheld device, and provides a two-way communication and control or message display function. It can increase use convenience and product application scope.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A remote control device for a set-top box with a two-way transmission function, comprising:
a set-top box having a transceiver device which includes a first receiving unit and a first transmitting unit; and
a handheld device including an input device, a second receiving unit corresponding to the first transmitting unit of the set-top box, a second transmitting unit corresponding to the first receiving unit of the set-top box and a display device;
wherein the second transmitting device transmits a control signal generated by the input device to the first receiving unit of the set-top box, the set-top box receiving the control signal and processing corresponding control functions, and generating a confirmation signal which is transferred to the first transmitting unit for transmitting to the handheld device, the second receiving unit of the handheld device receiving the confirmation signal, and the display device displaying the confirmation signal.

2. The remote control device of claim 1, wherein the receiving units and the transmitting units transmit signals through a transmission medium which is selected from a group consisting of infrared transmission and radio frequency transmission.

3. The remote control device of claim 1, wherein the display device is selected from a group consisting of indication lights, multi-stage LED, liquid crystal display panels, and touch display devices.

4. The remote control device of claim 1, wherein the input device is selected from a group consisting of keyboards, touch panels and touch display devices.

5. The remote control device of claim 1, wherein the first receiving unit and the first transmitting unit of the set-top box are separated and independent.

6. The remote control device of claim 1, wherein the second receiving unit and the second transmitting unit of the handheld device are separated and independent.

7. The remote control device of claim 1, wherein the first receiving unit and the first transmitting unit of the set-top box are coupled together.

8. The remote control device of claim 1, wherein the second receiving unit and the second transmitting unit of the handheld device are coupled together.

9. A remote controlling method for a set-top box with a two-way transmission function, comprising steps of:
a. entering at least one control signal from an input device of a handheld device, and transferring the control signal to a second transmitting unit of the handheld device;
b. transmitting the control signal entered from the input device through the second transmitting unit of the handheld device to a first receiving unit of a set-top box;
c. receiving the control signal transmitted from the second transmitting unit of the handheld device by the first receiving unit of the set-top box, and the control signal being received and processed by a processing unit of the set-top box to output a confirmation signal which is transferred to a first transmitting unit of the set-top box;
d. transmitting the confirmation signal from the first transmitting unit of the set-top box to a second receiving unit of the handheld device; and
e. receiving the confirmation signal transmitted from the first transmitting unit of the set-top box by the second receiving unit of the handheld device, and displaying the received confirmation signal on a display device of the handheld device.
